(19) United States
(12) Patent Application Publication
(10) Pub. No.: US 2026/0203791 A1
(43) Pub. Date: Jul. 16, 2026

(54) COVERAGE CONTROLLER FOR PACED DISTRIBUTION

(71) Applicant: Disney Enterprises, Inc., Burbank, CA (US)

(72) Inventors: Pengfei GAO, Irvine, CA (US); Yupeng GAO, Redmond, WA (US); Yan ZHANG, Bellevue, WA (US); Zhe WANG, Foster City, CA (US)

(21) Appl. No.: 19/022,047

(22) Filed: Jan. 15, 2025

(51) Int. Cl. G06Q 30/0251; G06Q 30/0242

(52) U.S. Cl. CPC G06Q 30/0255; G06Q 30/0246

(57) ABSTRACT

Embodiments provide for improved resource distribution. A first set of pacing results for a content distribution plan is accessed, and a target pacing for the content distribution plan is determined. A first coverage threshold is generated based on the first set of pacing results and the target pacing. A first ranking of a plurality of users is generated using a machine learning model and based on the content distribution plan, and distribution of content associated with the content distribution plan is facilitated based on the first ranking and the first coverage threshold.

### BACKGROUND

A wide variety of content (e.g., multimedia content such as video, audio, music, and the like) can be distributed according to an equally wide variety of distribution schemes and plans. In many cases, it is desirable to distribute or provide content in a targeted manner, improving the probability that the receiving user(s) will be interested in or otherwise engage with the delivered content. In some cases, how the user interacts or engages with the delivered content can be monitored to learn to predict future user engagement (whether for the same user or for other users) with the same content, similar content, and/or dissimilar content. For example, efforts have been made to predict whether a user will enjoy specific content, whether the user will engage more deeply with specific content (e.g., clicking the content, following a provided link, or otherwise requesting or seeking additional information about the content), and the like.

In some applications, distribution plans for media content are generated with goals related to such engagement. For example, a content provider may wish to distribute a given content asset in such a way a specified number of users will engage with or seek further information about the content. As one example, supplemental content providers (e.g., advertisers) who provide content that is distributed as supplemental media along with primary content (e.g., movies and television shows) often specify the desired number of users that will actually view and/or engage with the supplemental content under a given distribution plan.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 depicts an example system for paced distribution using a coverage controller, according to some embodiments of the present disclosure.

FIG. 2 depicts an example workflow for paced distribution using a coverage controller, according to some embodiments of the present disclosure.

FIG. 3 is a flow diagram depicting an example method for generating dynamic coverage thresholds for paced distribution, according to some embodiments of the present disclosure.

FIG. 4 is a flow diagram depicting an example method for paced distribution using dynamic coverage thresholds, according to some embodiments of the present disclosure.

FIG. 5 is a flow diagram depicting an example method for paced distribution, according to some embodiments of the present disclosure.

FIG. 6 depicts an example computing device configured to perform various embodiments of the present disclosure.

### DETAILED DESCRIPTION

In embodiments of the present disclosure, techniques are provided to improve resource distribution so as to ensure (or at least improve the probability of) adequate coverage of the resources (e.g., a sufficient distribution of resources and/or sufficient benefits accrued from such resources) with reduced computational expense.

Some approaches rely on heuristics-based and/or manually defined pacing. For example, if N interactions are desired in a given month, the content providers may define a static portion (e.g., 40%) of users that are expected to interact with the content. Based on this arbitrary value, content distribution may be modified (e.g., providing the content to more or fewer users) to target N total interactions in the month. However, such approaches are inherently inaccurate and inefficient. For example, if the predicted percentage of users who will engage with the content is set too low, there is a risk that the target will not be reached. This underperformance may be impermissible (or at least not preferred), and may further result in last-minute efforts to “catch-up” (e.g., over-delivering the content at the end of the month in an attempt to meet the target). This over-delivering results in substantial computational waste, as the content may be delivered to a relatively large number of users who would not otherwise receive it and/or who are less likely to engage with it. For example, network bandwidth is consumed by distributing the content to more users than needed, and this increased bandwidth may further be concentrated in a relatively small window of time (e.g., the last few days of the month), causing congestion and potential communication concerns. Relatedly, this increased bandwidth usage may incur significant costs (e.g., if a limited or capped data plan is used) and/or invoke undesirable network throttling. Also, if the predicted ratio is too high, the content delivery is less targeted than it could be (e.g., delivering the content to more users than should receive it), which similarly results in wasted computational expense (e.g., network bandwidth) due to delivering the content with poor targeting (e.g., to additional users who may be less likely to interact with it).

In some embodiments of the present disclosure, techniques for adaptive pacing via dynamically determined or estimated coverage thresholds are provided. Using the techniques described herein, computational expense of the content distribution can be reduced (e.g., because the amount of content distributed can more precisely match the amount that needs to be distributed to reach the target(s)). Further, the distribution can be more readily load balanced over time, reducing potential spikes in traffic (resulting in congestion) caused by inaccurate pacing.

In some embodiments, as discussed in more detail below, a significant portion of the computational resources used by the distribution planning can be expended offline (e.g., not in a real-time system), which allows the operations to be scheduled for non-peak times (e.g., overnight) when computational burden on the distribution systems is otherwise low. Further, fewer resources may be used by the planning process because the operations can be performed more slowly (e.g., offline because no user is awaiting the results) rather than in an online or time-sensitive manner.

Moreover, in some embodiments, a combination of machine learning and computationally efficient algorithms can be used to improve content pacing. That is, while machine learning may enable accurate and useful predictions, models tend to perform more accurately and with substantially less computational expense when the number of prediction dimensions is reduced (e.g., to predict a single outcome such as user engagement, rather than predicting multiple outcomes). In contrast, more efficient algorithms may use few computational resources, but are often less accurate for more complex tasks. In some embodiments, a combination of machine learning and efficient algorithms can be combined to solve the multi-dimensional pacing task, resulting in improved content distribution with reduced computational expense.

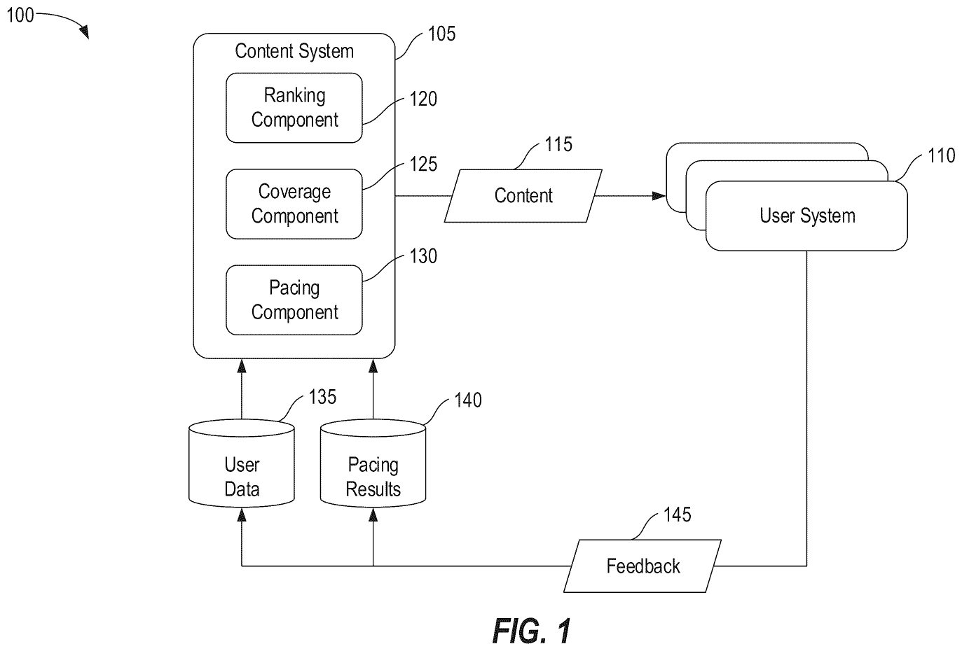

FIG. 1 depicts an example system 100 for paced distribution using a coverage controller, according to some embodiments of the present disclosure.

In the illustrated system 100, a content system 105 and a set of one or more user systems 110 are communicatively coupled. Although not depicted in the illustrated example, the content system 105 and user system(s) 110 may generally be coupled by any number and combination of wired and/or wireless links, including the Internet. Generally, the user system(s) 110 correspond to computing devices (e.g., smart televisions, smartphones, laptops, desktop computers, tablets, streaming devices, and the like) used by users to receive or consume media (e.g., the content 115). The content 115 is generally representative of any combination of media content, including audio, video, multimedia, text, and the like. The content 115 may include primary content (e.g., content which the user specifically requests to view, such as television shows or movies) and/or supplemental content (e.g., content which is provided along with primary content but without an explicit request for such supplemental content, such as advertisements, trivia or fun facts relating to the primary content, behind-the-scenes information, and the like). Although not depicted in the illustrated example, in some embodiments, some or all of the user system(s) 110 may include one or more applications to facilitate the content delivery (e.g., streaming applications).

Although the illustrated system 100 includes a discrete content system 105 for conceptual clarity, in some embodiments, the operations of the content system 105 may be combined or distributed across any number and variety of systems and devices, and may generally be implemented using hardware, software, or a combination of hardware and software. In the illustrated example, the content system 105 includes a ranking component 120, a coverage component 125, and a pacing component 130. Although depicted as discrete components for conceptual clarity, the depicted components (and others not illustrated) may be combined or distributed across any number of hardware and/or software components.

In the illustrated example, the ranking component 120 may be used to rank content assets and/or users based on information such as user data 135. The user data 135 may generally include any information describing characteristics of the user, such as the user's age, gender, cultural background, preferences, hobbies, and the like. For example, in some aspects, the ranking component 120 may generate scores indicating the probability that a given user will interact with a given content asset (e.g., a given advertisement), such as by scanning the content, selecting or clicking the content for more information, and the like. In some embodiments, the ranking component 120 uses a machine learning model (which may be trained continuously or periodically, such as daily). For example, the ranking component 120 may use interaction data (e.g., user data 135) from the prior window of time (e.g., the prior day) in order to train or refine the machine learning model to predict whether each user will interact with one or more content assets in the future (e.g., during the current window of time, such as the current day). In some aspects, the set of users corresponds to all users of the content system 105 (e.g., all users who consume content from the content system 105). In some embodiments, the set of users corresponds to users meeting one or more targeting criteria for the particular content asset (e.g., in the target demographic, such as the target age, gender, and the like).

In some embodiments, after the model has been trained and/or refined, the ranking component 120 can use the machine learning model to rank a set of users based on their predicted interaction probability for a given content asset that is being evaluated. That is, if the content system 105 is monitoring or controlling distribution of a first content asset (e.g., a first piece of media), the ranking component 120 may be used to predict, for each user of a set of users (e.g., users of the user systems 110 who consume media or content from the content system 105), the probability that the respective user will engage or interact with the content asset.

In the illustrated example, the coverage component 125 may generally be used to determine or predict a coverage threshold (e.g., the percentage of users who, if delivered the content asset, will interact or engage with the content in the desired manner(s)) for the content asset. For example, the coverage component 125 may predict the proportion of users receiving the content that will seek more information for the content (e.g., by clicking on the content). In some embodiments, the coverage component 125 makes this prediction based at least in part on the pacing results 140, which may indicate the actual coverage threshold(s) observed for one or more prior windows of time (e.g., the prior day).

For example, suppose the content distribution plan corresponds to a plurality of windows of time (e.g., thirty days over a one month duration), and the coverage component 125 is used to make predictions for each window of time (e.g., each day). In some embodiments, the coverage component 125 may evaluate information such as the previous pacing results 140 from one or more prior windows of time (e.g., from days zero through t-1, where the current day is day t). In some embodiments, the coverage component 125 may additionally or alternatively evaluate information such as the previous completions (e.g., the number of content interactions that have already occurred during the prior windows, such as the number of times a user has clicked on the content so far during the month). In some embodiments, the coverage component 125 may additionally or alternative evaluate information such as the target total number of interactions for the plan (e.g., the desired number of clicks for the distribution plan).

For example, based on the number of content interactions already achieved, the number of windows of time (e.g., days) remaining in the plan, and the target total number of interactions, the coverage component 125 may determine how many interactions are needed per window (e.g., at least for the current day) to maintain pacing towards the target. In some embodiments, the coverage component 125 may generate the coverage threshold as a percentage (e.g., the predicted percentage of users who will engage with the content if it is delivered). In some embodiments, the coverage component 125 may generate the coverage threshold as a number of users (e.g., given the size of the segment of users that meet the target characteristics for the content) that will engage with the content.

Generally, the coverage component 125 may use a variety of techniques and operations to generate the coverage threshold. For example, in some embodiments, the coverage component 125 uses a linear approximation based on prior pacing results 140 to generate the coverage threshold. In some embodiments, the linear approximation may be defined such that the coverage component 125 seeks to find an optimal solution u* such that M(u*)=g, where u is the daily segment size (e.g., number of users selected to be in the segment during a given window of time, determined based on the coverage threshold), M (u) is a function to map the daily segment size to the daily completion number (e.g., where the daily completion number indicates the number of users in the segment who interacted with the content on one or more prior days), and g is the daily goal or target (e.g., the number of interactions desired for the current window to stay on pace).

In some embodiments, the coverage component 125 may define M(u)=r*u where

$$r = \frac{{C}_{t - 1}}{{u}_{t - 1}} , {C}_{t - 1}$$

is the completion number of the previous time window (e.g., the previous day), and uₜ₋₁ is the segment size of the previous time window (e.g., the coverage threshold. Therefore, to solve the linear function, the coverage component 125 may use Equation 1 below to generate the coverage threshold for the current day.

$${u}_{t} = {u}_{t - 1} + \frac{( g - {C}_{t - 1} )}{r} \qquad ( 1 )$$

That is, using Equation 1, the coverage component 125 may generate the coverage threshold (e.g., the daily segment size) uₜ indicating the percentage of users and/or total number of users that should be included in the target segment to whom the specific content asset is delivered during the current window.

In some embodiments, the coverage component 125 may additionally or alternatively use more complex formulations for M(u), even if the particular function is not directly observable. For example, the coverage component 125 may use stochastic approximators such as the Robbins-Monro algorithm to find the optimal value for u* iteratively using Equation 2 below, where N(u) is a random variable to introduce an element of randomness to the solution, E[N(u)]=M(u) (e.g., the expected value of the random variable is M(u)), N(u) is uniformly bounded, M(u) is non-descending, the gradient M′(u) exists and is positive,

$${\sum }_{t = 0}^{∞} {α}_{t} = ∞ , and {\sum }_{t = 0}^{∞} {α}_{t}^{2} < ∞ .$$

$${u}_{t} = {u}_{t - 1} - {α}_{t - 1} ( N ( {u}_{t - 1} ) - g ) \qquad ( 2 )$$

In some embodiments, the coverage threshold (generated by the coverage component 125) and the ranked set of users (generated by the ranking component 120) can be provided to the pacing component 130 for further evaluation. In some solutions, as the user segment (e.g., the ranked list of users) may be updated relatively infrequently (e.g., once per day), conventional systems may generate the target segment by selecting the indicated number of users from the total pool of ranked users based on the coverage threshold (e.g., the top N % or the top M users), and provide this target segment to the pacing component 130. In some embodiments of the present disclosure, the total ranked list and the coverage threshold itself may instead be provided to the pacing component 130 (or other targeting service), thereby decoupling the coverage threshold from the user list and allowing the coverage threshold to be updated much more rapidly (e.g., multiple times a day), even while the user rankings remain fixed during each window. This can enable more flexible adaptation to pacing status changes, even within a single window (e.g., within a single day) and without updating the user rankings.

In some embodiments, as the coverage threshold may be generated with relatively less computational expense as compared to the user rankings (which are generated using machine learning), this decoupling can further allow more frequent targeting updates with reduced computational expense, as compared to conventional systems (e.g., which rely only on machine learning models for each step).

In the illustrated example, the pacing component 130 may then be used to select the actual content 115 that is delivered to each user system 110. Although the illustrated example suggests a single content asset being provided to all user systems 110, in embodiments, the pacing component 130 may select any number and variety of specific content assets for each user.

For example, in some embodiments, when requests for content can be provided to the content system 105. These requests may include direct requests (e.g., from a user system 110) for specific content and/or for any suggested or supplemental content, and/or may include indirect requests. For example, when the user system 110 requests or accesses a selection of primary content from one system, that primary system may request that the content system 105 provide corresponding supplemental content for the user.

In some embodiments, when a request for such content is received, the pacing component 130 (or another component) can identify or generate a list of targeted content assets for the particular request based on characteristics of the request and/or the requesting user. For example, the pacing component 130 (or another component) may evaluate a corpus or repository of content assets, where each content asset has an accompanying set of criteria or targeting rules specifying when the content asset should be used (e.g., specifying the various characteristics of the user(s) for whom the content is targeted, such as their profession, age, geographic location, hobbies, age(s), gender(s), or any other characteristics). In some embodiments, the pacing component 130 may generate a list of candidate content items by adding any content assets having criteria that are satisfied by the request and/or corresponding user.

Further, in some embodiments, the generated user segment (e.g., the target segment discussed above, which may be generated or selected based on the coverage threshold) may be used as a targeting rule. For example, the pacing component 130 may use the coverage threshold to determine that the top M (or the top N %) of users in the total set are included in the target segment, and may only include the content in the set of candidate content assets for a given user if the given user meets all of the asset criteria (including that the user is in the target segment).

The pacing component 130 (or another component) may then evaluate this set of candidate content assets to select a specific set of one or more content assets to be delivered to the user in response to the content request (e.g., based on pacing status and yield, scores indicating the probability of engagement with each asset, whether the user has already seen the asset, and the like).

In these ways, the content system 105 takes the pacing status of each content asset (in the context of the corresponding distribution plans) into account when delivering content 115 to user systems 110.

In the illustrated example, the user systems 110 may optionally provide feedback 145 to the content system 105 (via the user data 135 and/or pacing results 140) based on the delivered content 115. For example, the feedback 145 may indicate whether and/or how the user engaged with the content (e.g., whether they clicked on it, searched or scanned it, and the like). In this way, the user data 135 can be updated (allowing the ranking component 120 to learn how to better predict how the specific user will respond to content). Similarly, the pacing results 140 can be updated (allowing the coverage component 125 to generate updated coverage thresholds to maintain the content pacing).

In some embodiments, as discussed above, the content system 105 can dynamically update the user segments based on the previous pacing results 140 (e.g., for the prior day or days). For example, by comparing the daily goal with the daily completions for the previous day, the content system 105 can determine a new daily goal for the current day. If the completions are less than the goal (or otherwise fail to meet any relevant criteria), the content system 105 may increase the coverage threshold as compared to the previous threshold (automatically addressing under-pacing risk by seeking to achieve more completions in order to maintain distribution pace). Otherwise, the content system 105 may reduce the coverage threshold (e.g., to only serve the high-interactive ratio users without affecting the pacing status). This exclusion of low-interactive users when there is little or no under-pacing risk can increase the overall interaction ratios of the content delivery, thereby optimizing (e.g., reducing) computational resource usage to deliver the content 115.

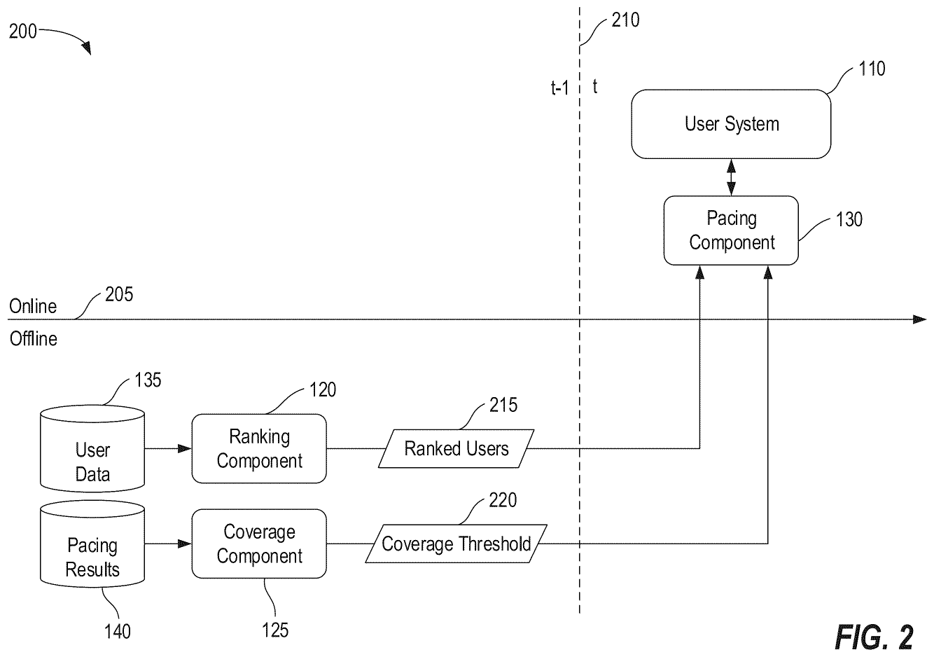

FIG. 2 depicts an example workflow 200 for paced distribution using a coverage controller, according to some embodiments of the present disclosure. In some embodiments, the workflow 200 may be performed by a content system, such as the content system 105 of FIG. 1.

In the illustrated example, the workflow 200 is delineated into an online portion and an offline portion, as indicated by the arrow 205. Specifically, operations above the arrow 205 may represent operations performed online (e.g., in real-time, such as responsive to user requests) while operations below the arrow 205 may represent operations performed offline (e.g., not in real-time and/or not in response to a user request, such as overnight). Further, as illustrated by the dotted vertical line 210, the workflow 200 may take place over multiple days (or other windows of time, such as weeks). Specifically, operations on the left of the vertical line 210 may be performed during a first window (e.g., on day t-1) while operations on the right of the vertical line 210 may be performed during the subsequent window (e.g., on day t). In some embodiments, the delineation between windows in the workflow 200 (indicated by the vertical line 210) may not occur specifically at the transition between days or other corresponding periods. That is, the delineation may not occur at midnight. For example, in some embodiments, the operations performed for day t-1 may be performed after midnight but before a designated time in the morning (e.g., between three and five in the morning).

In the illustrated example, during a first window of time corresponding to t-1 (or based on data collected during the first window of time), the ranking component 120 evaluates user data 135 to generate a set of ranked users 215 (e.g., a list of users ordered based on how likely each user is to engage with a given content asset) and the coverage component 125 evaluates pacing results 140 to generate an updated coverage threshold 220. For example, as discussed above, the ranked users 215 may be generated using one or more machine learning models to predict engagement probability, and the coverage threshold 220 may be generated using one or more algorithms, such as Equations 1 and/or 2 above.

In the illustrated workflow 200, the ranked users 215 and the coverage threshold 220 are generated based on data (e.g., the user data 135 and the pacing results 140) generated and/or collected during a first day t-1. In some embodiments, the ranked users 215 and the coverage threshold 220 may or may not actually be generated on the same day t-1. Because the ranked users 215 and coverage threshold 220 are generated offline, the particular time when they are generated may not be relevant to the workflow 200, so long as they have been generated prior to the online stage.

As illustrated, in the online stage during the subsequent day t, the ranked users 215 and the coverage threshold 220 are used by the pacing component 130 to interact with users system(s) 110 (e.g., to select and deliver content, as discussed above). In this way, updated data from the prior window of time (e.g., the prior day) can be used to pace content delivery on the adjacent window of time (e.g., the current day). Although not depicted in the illustrated workflow 200, in some embodiments, the interactions or engagement of users with the content on the day t (e.g., updated user data and/or pacing results) may similarly be used (offline) to generate an updated set of ranked users and/or an updated coverage threshold on day t. This updated data may then be used on the next day (e.g., day t+1) to drive content distribution during the next day. Similarly, though not depicted in the illustrated example, the pacing component 130 may deliver content online during the first window t−1 using user rankings and coverage threshold(s) generated offline during (or based on data corresponding to) the prior window t−2.

Additionally, although the illustrated workflow 200 depicts generating a single coverage threshold 220 each window, in some embodiments, the content system may generate multiple coverage thresholds per window, as discussed above. For example, although generating the list of ranked users 215 may involve machine learning (which may be fairly computationally complex), the content system may generate updated coverage thresholds 220 with relatively little computational complexity and expense. In some embodiments, therefore, the content system may use updated pacing results 140 throughout a window of time (e.g., during the t-th day) to generate updated coverage thresholds 220 multiple times during the window (e.g., every five minutes, every hour, and the like). These frequently updated coverage thresholds can then be used on the same t-th day, along with the previously generated set of ranked users 215 for the t-th day, to provide highly dynamic and adaptive distribution pacing at a granular level, further improving the technology as discussed above (e.g., enabling reduced computational expense and waste, such as reduced network bandwidth and computational costs to prepare and transmit the content to broader segments).

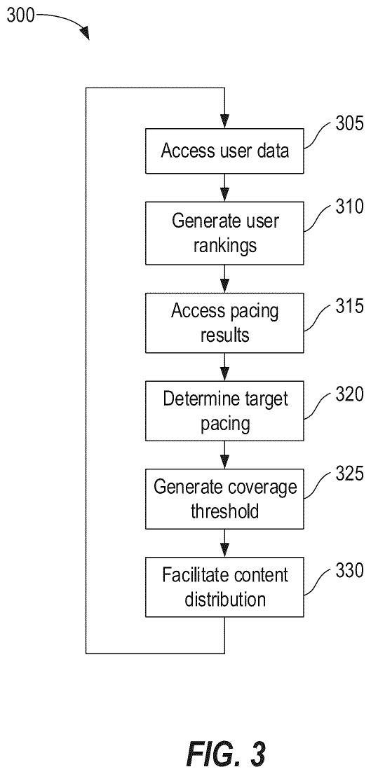

FIG. 3 is a flow diagram depicting an example method 300 for generating dynamic coverage thresholds for paced distribution, according to some embodiments of the present disclosure. In some embodiments, the method 300 may be performed by a content system, such as the content system 105 of FIG. 1 and/or the content system discussed above with reference to FIG. 2. In some embodiments, the method 300 is performed separately for each content asset that is being distributed and/or paced by the content system. In some embodiments, the method 300 provides additional detail for the offline operations of the workflow 200 (e.g., the operations performed below the arrow 205).

At block 305, the content system accesses user data (e.g., the user data 135 of FIGS. 1-2). As used herein, “accessing” data may generally include receiving, requesting, retrieving, obtaining, collecting, generating or otherwise gaining access to the data. Generally, the user data includes any user information that may be used to predict the probability that a given user will interact or engage with one or more content assets (e.g., the probability that the user will click or scan the content). For example, as discussed above, the user data may include information such as various characteristics of the user (e.g., preferences, hobbies, locations, demographics, and the like), information relating to how the user previously interacted (or declined to interact with) prior content asset delivery, and the like.

At block 310, the content system generates user rankings (e.g., the ranked users 215 of FIG. 2) based on the user data. For example, as discussed above, the content system may refine or train one or more machine learning models based on the updated user data (e.g., data collected during the previous day), and may then use this updated model to predict, for each respective content asset of a library of content, the probability that each of a plurality of users will interact with the content in one or more desired or specified ways (e.g., by clicking the content or requesting more information). These probabilities can then be used to rank or sort the users (e.g., where users more likely to interact with the content are nearer to the top of the list, as compared to users that are less likely to interact with the content). In some embodiments, the content system can then generate the user rankings on a per-content asset basis (e.g., where each content asset has a corresponding set of user rankings, ordered based on the probability of engagement).

At block 315, the content system accesses a set of updated pacing results (e.g., the pacing results 140 of FIGS. 1-2). Generally, as discussed above, the pacing results may include information relating to how users interacted or engaged with one or more content assets during a most recent window of time (e.g., the prior day). For example, if a given content asset has an associated content distribution plan specifying one or more targets or goals relating to interaction statistics (e.g., a target number of interactions, impressions, reach, frequency, number of clicks, number of scans, and the like), the pacing results may include information about these statistics for the previous day (e.g., the number of impressions during the previous day). In some embodiments, the pacing results may additionally or alternatively indicate the portion or percentage of users that interacted with the content asset, as compared to the total number of users that received the content asset. For example, if the target segment (e.g., the number of users that were selected to receive the content asset) had N users, the pacing results may indicate the percentage (e.g., M %) of the N users that interacted with the content, and/or the total number (e.g., M) of users that interacted with the content.

At block 320, the content system determines a pacing target for the content asset. In some embodiments, as discussed above, the content system may determine the new or updated pacing target based on the overall target or goal of the corresponding distribution plan, the current progress towards that goal, and/or the time remaining before the end of the plan. For example, the content system may determine the total number of content interactions that have occurred during the plan duration (e.g., from the first window of time when the plan began, through the immediately prior window of time, such as yesterday), the number of windows of time (e.g., days) remaining in the plan, and the target total number of content interactions given by the content distribution plan. In some embodiments, the target pacing may refer to the total target or goal of the plan, in addition to or instead of the updated per-day (or other window) target.

At block 325, the content system generates an updated coverage threshold based on the target pacing (e.g., based on the pacing results thus far and the total goals of the plan). For example, as discussed above, the content system may use algorithms such as given in Equations 1 or 2 above to generate the coverage threshold. As discussed above, the coverage threshold may generally indicate the number or percentage of users that are predicted to interact with the content. For example, if the total population of the user rankings is M (e.g., the number of users who meet the targeting criteria for the content, such as by age or other demographics), the coverage threshold may indicate that N % of the segment are expected to interact with the content and/or that N users from the set of M are expected to interact with the content.

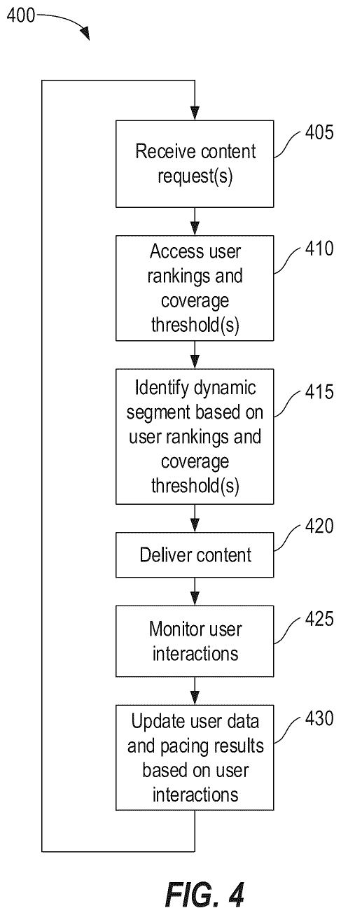

At block 330, the content system facilitates content distribution based on the updated coverage threshold and user rankings. For example, as discussed above, the content system may use the coverage threshold to generate a dynamic segment for the content (e.g., by selecting a subset of the total user segment based on the user rankings (e.g., selecting the top N users or the top N % of the users)). This subset may correspond to the set of users that will or should receive the content asset during the current window. The content system (or another system) may then provide, or cause to be provided, the content asset to the dynamic segment of users. One method for facilitating content distribution is provided in more detail below with reference to FIG. 4.

The method 300 then returns to block 305 to begin anew (e.g., during the next window of time, such as the next day).

FIG. 4 is a flow diagram depicting an example method 400 for paced distribution using dynamic coverage thresholds, according to some embodiments of the present disclosure. In some embodiments, the method 400 may be performed by a content system, such as the content system 105 of FIG. 1 and/or the content system discussed above with reference to FIGS. 2-3. In some embodiments, the method 400 provides additional detail for block 330 of FIG. 3. In some embodiments, the method 400 provides additional detail for the online operations of the workflow 200 (e.g., the operations performed above the arrow 205).

At block 405, the content system receives one or more content requests. In some embodiments, as discussed above, the content request may explicitly or implicitly request that the content system select one or more supplemental content assets to be provided. For example, the request may be received from a user system (e.g., the request may be for a specific piece of content, where the content system determines to also select one or more other content items to provide) or from another system (e.g., another computing system that is already providing, or is preparing to provide, other content to the user).

At block 410, the content system accesses a set of user rankings (e.g., the ranked users 215 of FIG. 2, which may be generated at block 310 of FIG. 3) for a given content asset, as well as cover threshold(s) (e.g., the coverage threshold 220 of FIG. 2, which may be generated at block 325 of FIG. 3) for the given content asset. In some embodiments, the content system can perform blocks 410-430 separately for each content asset that is being distributed and/or paced by the content system. That is, each individual content asset may be evaluated separately (e.g., based on a corresponding set of user rankings and coverage threshold(s)).

At block 415, the content system identifies or generates a dynamic segment of users for the content assets based on the user rankings and the coverage threshold. For example, as discussed above, from the total set of users that fit the content's criteria (e.g., the users in the user rankings), the content system may generate a dynamic segment of users to whom the content asset should be delivered (in the current window of time) by selecting the top one or more users (sorted based on their rankings and selected based on the coverage threshold).

At block 420, the content system delivers the content to user(s) in the generated dynamic segment. For example, the content system may transmit the content (or a link to the content) to the user system. The content may then be output in various ways, such as via a graphical user interface (GUI), speaker, and the like. In some embodiments, the selected content is output in conjunction with other content (e.g., as a supplemental content item), such as between portions of primary content, in a designated area or portion of the GUI along with the primary content, via a separate output (e.g., on a second screen or device, while the primary content is displayed on a primary screen or device), and the like.

At block 425, the content system monitors user interaction(s) with the provided content asset(s). For example, as discussed above, the content system may monitor whether the user interacts or engages with the content asset (e.g., by clicking or scanning it to retrieve more information, by indicating interest or a request for further information immediately or subsequently, and the like).

At block 430, based on the monitored interaction(s), the content system can update the user data and/or pacing results. For example, the content system may update the user data and the pacing results to indicate that the user did (or did not) interact with the content. This can enable improved future generation of user rankings and coverage thresholds (e.g., for the subsequent day). The method 400 then returns to block 405 (e.g., for the next day and/or next content asset).

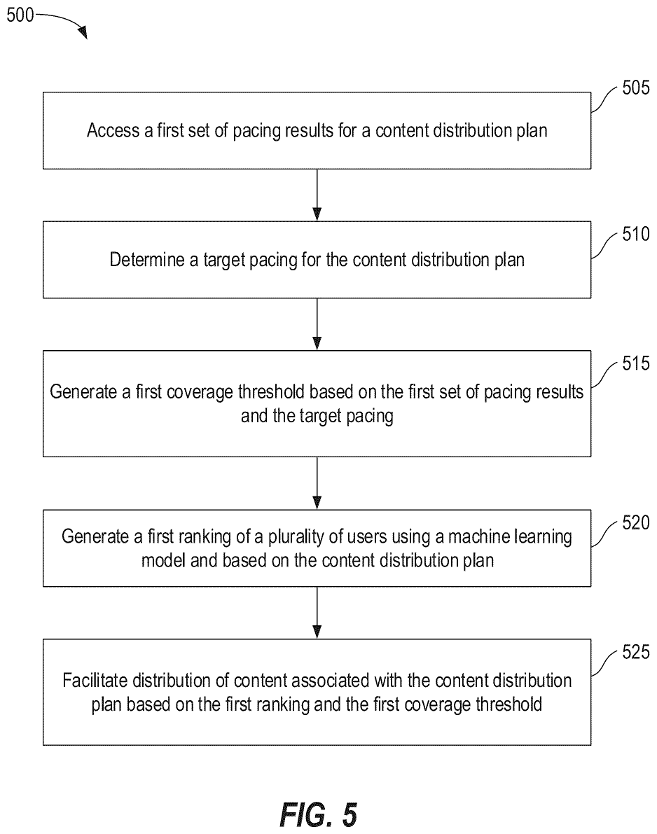

FIG. 5 is a flow diagram depicting an example method 500 for paced distribution, according to some embodiments of the present disclosure. In some embodiments, the method 500 may be performed by a content system, such as the content system 105 of FIG. 1 and/or the content system discussed above with reference to FIGS. 2-4.

At block 505, a first set of pacing results (e.g., the pacing results 140 of FIG. 1) for a content distribution plan is accessed.

At block 510, a target pacing for the content distribution plan is determined.

At block 515, a first coverage threshold (e.g., the coverage threshold 220 of FIG. 2) is generated based on the first set of pacing results and the target pacing.

At block 520, a first ranking of a plurality of users (e.g., the ranked users 215 of FIG. 2) is generated using a machine learning model and based on the content distribution plan.

At block 525, distribution of content (e.g., the content 115 of FIG. 1) associated with the content distribution plan is facilitated based on the first ranking and the first coverage threshold.

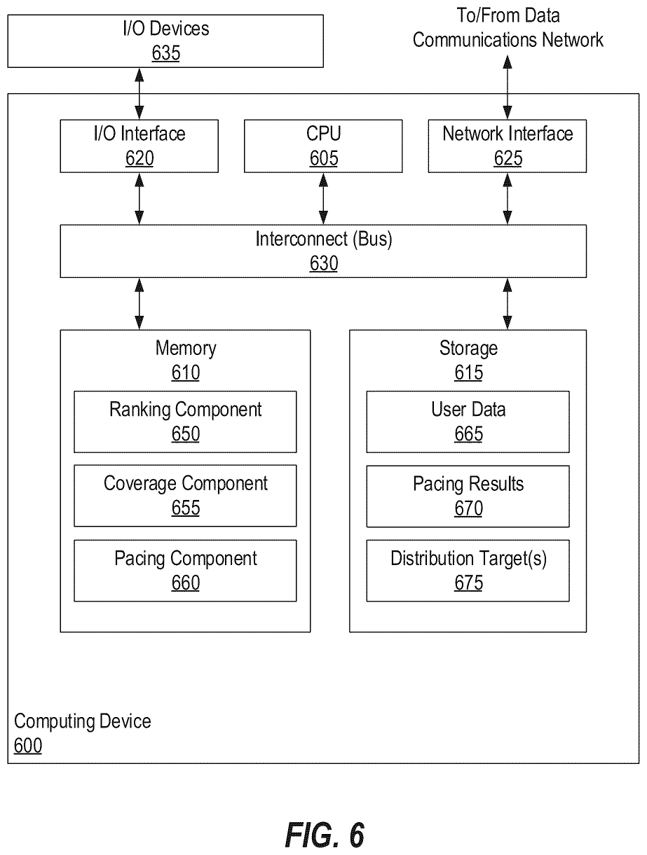

FIG. 6 depicts an example computing device 600 configured to perform various embodiments of the present disclosure. Although depicted as a physical device, in embodiments, the computing device 600 may be implemented using virtual device(s), and/or across a number of devices (e.g., in a cloud environment). In one embodiment, the computing device 600 corresponds to or implements a content system, such as the content system 105 of FIG. 1 and/or the content systems discussed above with reference to FIGS. 2-5.

As illustrated, the computing device 600 includes a CPU 605, memory 610, a network interface 625, and one or more I/O interfaces 620. Though not included in the depicted example, in some embodiments, the computing device 600 also includes one or more storages. In the illustrated embodiment, the CPU 605 retrieves and executes programming instructions stored in memory 610, as well as stores and retrieves application data residing in memory 610 and/or storage (not depicted). The CPU 605 is generally representative of a single CPU and/or GPU, multiple CPUs and/or GPUs, a single CPU and/or GPU having multiple processing cores, and the like. The memory 610 is generally included to be representative of a random access memory. In an embodiment, if storage is present, it may include any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, network interface(s) 625, and I/O interface(s) 620 are communicatively coupled by one or more buses 630.

In the illustrated embodiment, the memory 610 includes a ranking component 650, a coverage component 655, and a pacing component 660, which may perform one or more embodiments discussed above. Although depicted as discrete components for conceptual clarity, in embodiments, the operations of the depicted components (and others not illustrated) may be combined or distributed across any number of components. Further, although depicted as software residing in memory 610, in embodiments, the operations of the depicted components (and others not illustrated) may be implemented using hardware, software, or a combination of hardware and software.

The ranking component 650 (which may correspond to the ranking component 120 of FIGS. 1-2) may generally be used to evaluate and rank users based on the probability that they will engage or interact with one or more content assets using machine learning, as discussed above. For example, the ranking component 650 may access user data to train or refine the model(s) (e.g., daily), and may then use the updated model(s) to generate predictions as to the probability that each user will interact with the content. These predictions can then be used to rank or sort the users (e.g., to generate the ranked users 215 of FIG. 2).

The coverage component 655 (which may correspond to the coverage component 125 of FIGS. 1-2) may generally be used to generate coverage thresholds to improve distribution pacing, as discussed above. For example, the coverage component 655 may evaluate pacing history and/or pacing targets (per day and/or over the entire plan duration) to generate updated thresholds indicating how many users should be provided with the content on a given day (or other window of time).

The pacing component 660 (which may correspond to the pacing component 130 of FIGS. 1-2) may generally be used to pace or manage the distribution of content assets in accordance with the distribution plans, user rankings, and coverage thresholds, as discussed above. For example, the pacing component 660 may generate dynamic user segments based on the user rankings and the coverage threshold (e.g., selecting the highest-scored users, as discussed above), and may then distribute (or facilitate distribution of) the content to the selected users.

In the illustrated example, the storage 615 includes user data 665, pacing results 670, and distribution targets 675. Although depicted as residing in storage 615, the depicted data may be stored in any suitable location.

Generally, the user data 665 (which may correspond to the user data 135 of FIG. 1) may comprise any user information used to generate user rankings (e.g., to predict the probability that the user will interact or engage with one or more content assets). The pacing results 670 (which may correspond to the pacing results 140 of FIGS. 1-2) may comprise information about how many users and/or what percentage of users interacted with a given content asset after delivery during one or more prior windows of time, as discussed above. The distribution targets 675 may indicate per-window and/or per-distribution plan goals for content delivery, such as a number of impressions, a number of clicks, and the like.

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

1. A method, comprising:
accessing a first set of pacing results for a content distribution plan for a prior window of time;
determining a target pacing for the content distribution plan;
generating, during an online phase, a first coverage threshold using a coverage threshold algorithm and based on the first set of pacing results and the target pacing, the first coverage threshold indicating a number of users, from a plurality of users, to receive content associated with the content distribution plan;
generating, during an offline phase prior to the online phase, a first ranking of the plurality of users using a machine learning model and based on the content distribution plan, wherein:
the machine learning model was trained to predict a single outcome for each respective user of the plurality of users, and
the coverage threshold algorithm incurs less computational expense, as compared to the machine learning model;
facilitating distribution of content associated with the content distribution plan based on the first ranking and the first coverage threshold during a second window of time, the second window of time occurring during the online phase;
accessing a second set of pacing results for the content distribution plan for the second window of time during the online phase;
generating, during the online phase, a second coverage threshold using the coverage threshold algorithm and based on the second set of pacing results; and
facilitating distribution of content associated with the content distribution plan based on the first ranking and the second coverage threshold during a third window of time, the third window of time occurring during the online phase.

2. The method of claim 1, wherein the first set of pacing results indicate:
a previous coverage threshold for the prior window of time, and
a number of content interactions associated with the content distribution plan during the prior window of time.

3. The method of claim 2, wherein:
the content distribution plan corresponds to a first duration comprising a plurality of windows of time, and
the second window of time is immediately subsequent to the prior window of time.

4. The method of claim 3, wherein the target pacing is determined based on:
a total number of content interactions that have occurred during the first duration through the prior window of time,
a number of windows of time remaining in the plurality of windows of time, and
a target total number of content interactions for the content distribution plan.

5. The method of claim 1, wherein the first coverage threshold algorithm comprises at least one of (i) a linear approximation, or (ii) a stochastic approximator.

6. The method of claim 1, wherein the first ranking of the plurality of users indicates, for each respective user of the plurality of users, a respective probability that the respective user will interact with the content associated with the content distribution plan.

7. The method of claim 1, wherein facilitating distribution of content during the second window of time comprises:
generating a dynamic segment of users, corresponding to a subset of the plurality of users, based on the first ranking and the first coverage threshold; and
facilitating distribution of the content to one or more users in the dynamic segment of users.

8. The method of claim 1, further comprising:
accessing a third set of pacing results for the content distribution plan;
determining an updated target pacing for the content distribution plan;
generating a third coverage threshold based on the third set of pacing results and the updated target pacing;
generating a second ranking of the plurality of users using the machine learning model and based on the content distribution plan; and
facilitating distribution of content associated with the content distribution plan based on the second ranking and the third coverage threshold.

9. One or more non-transitory computer readable media containing, in any combination, computer program code that, when executed by operation of any combination of one or more processors, performs an operation comprising:
accessing a first set of pacing results for a content distribution plan for a prior window of time;
determining a target pacing for the content distribution plan;
generating, during an online phase, a first coverage threshold using a coverage threshold algorithm and based on the first set of pacing results and the target pacing, the first coverage threshold indicating a number of users, from a plurality of users, to receive content associated with the content distribution plan;
generating, during an offline phase prior to the online phase, a first ranking of the plurality of users using a machine learning model and based on the content distribution plan, wherein:
the machine learning model was trained to predict a single outcome for each respective user of the plurality of users, and
the coverage threshold algorithm incurs less computational expense, as compared to the machine learning model;
facilitating distribution of content associated with the content distribution plan based on the first ranking and the first coverage threshold during a second window of time, the second window of time occurring during the online phase;
accessing a second set of pacing results for the content distribution plan for the second window of time during the online phase;
generating, during the online phase, a second coverage threshold using the coverage threshold algorithm and based on the second set of pacing results; and
facilitating distribution of content associated with the content distribution plan based on the first ranking and the second coverage threshold during a third window of time, the third window of time occurring during the online phase.

10. The one or more non-transitory computer readable media of claim 9, wherein the first set of pacing results indicate:
a previous coverage threshold for the prior window of time, and
a number of content interactions associated with the content distribution plan during the prior window of time.

11. The one or more non-transitory computer readable media of claim 10, wherein:
the content distribution plan corresponds to a first duration comprising a plurality of windows of time, and
the second window of time is immediately subsequent to the prior window of time.

12. The one or more non-transitory computer readable media of claim 9, wherein the first coverage threshold algorithm comprises at least one of (i) a linear approximation, or (ii) a stochastic approximator.

13. The one or more non-transitory computer readable media of claim 9, wherein the first ranking of the plurality of users indicates, for each respective user of the plurality of users, a respective probability that the respective user will interact with the content associated with the content distribution plan.

14. The one or more non-transitory computer readable media of claim 9, wherein facilitating distribution of content during the second window of time comprises:
generating a dynamic segment of users, corresponding to a subset of the plurality of users, based on the first ranking and the first coverage threshold; and
facilitating distribution of the content to one or more users in the dynamic segment of users.

15. A system, comprising:
one or more processors; and
one or more memories storing a program, which, when executed on any combination of the one or more processors, performs operations, the operations comprising:
accessing a first set of pacing results for a content distribution plan for a prior window of time;
determining a target pacing for the content distribution plan;
generating, during an online phase, a first coverage threshold using a coverage threshold algorithm and based on the first set of pacing results and the target pacing, the first coverage threshold indicating a number of users, from a plurality of users, to receive content associated with the content distribution plan;
generating, during an offline phase prior to the online phase, a first ranking of the plurality of users using a machine learning model and based on the content distribution plan, wherein:
the machine learning model was trained to predict a single outcome for each respective user of the plurality of users, and
the coverage threshold algorithm incurs less computational expense, as compared to the machine learning model;
facilitating distribution of content associated with the content distribution plan based on the first ranking and the first coverage threshold during a second window of time, the second window of time occurring during the online phase;
accessing a second set of pacing results for the content distribution plan for the second window of time during the online phase;
generating, during the online phase, a second coverage threshold using the coverage threshold algorithm and based on the second set of pacing results; and
facilitating distribution of content associated with the content distribution plan based on the first ranking and the second coverage threshold during a third window of time, the third window of time occurring during the online phase.

16. The system of claim 15, wherein the first set of pacing results indicate:
a previous coverage threshold for the prior window of time, and
a number of content interactions associated with the content distribution plan during the prior window of time.

17. The system of claim 16, wherein:
the content distribution plan corresponds to a first duration comprising a plurality of windows of time, and
the second window of time is immediately subsequent to the prior window of time.

18. The system of claim 15, wherein the first-coverage threshold algorithm comprises at least one of (i) a linear approximation, or (ii) a stochastic approximator.

19. The system of claim 15, wherein the first ranking of the plurality of users indicates, for each respective user of the plurality of users, a respective probability that the respective user will interact with the content associated with the content distribution plan.

20. The system of claim 15, wherein facilitating distribution of content during the second window of time comprises:
generating a dynamic segment of users, corresponding to a subset of the plurality of users, based on the first ranking and the first coverage threshold; and
facilitating distribution of the content to one or more users in the dynamic segment of users.
